(19) United States
(12) Patent Application Publication
(10) Pub. No.: US 2007/0027735 A1
(43) Pub. Date: Feb. 1, 2007

(54) METHODS AND APPARATUS FOR MANAGING A PLURALITY OF GEOGRAPHICALLY DISPERSED PROPERTIES

(76) Inventor: Mark Rokos, Batavia, IL (US)

Correspondence Address: BELL, BOYD & LLOYD, LLC, PO BOX 1135, CHICAGO, IL, 60690-1135, US

(21) Appl. No.: 11/460,518

(22) Filed: Jul. 27, 2006

Related U.S. Application Data
(60) Provisional application No. 60/702,884, filed on Jul. 27, 2005.

(51) Int. Cl. G06F 9/44

(52) U.S. Cl. 705/7

(57) ABSTRACT

Methods and apparatus to manage a plurality of geographically dispersed residential properties are disclosed. The methods and apparatus enable a plurality of rental properties to be managed by a central property management system despite the facts that in some areas, full time professional property managers are not available, the individual rental properties may be too small to justify a dedicated property manager and may be located in a plurality of different, and possibly remote, geographic regions. The methods described greatly reduce the time required and knowledge needed for real estate agents to manage residential properties. The method of delivery enables virtually any real estate agent to manage residential properties regardless of their physical location volume of properties or training in property management. Certain of the property management functions are performed automatically by a central computer that is part of the central property management system. Other property management functions are performed by the central property management system with the assistance of one or more central property managers. Still other property management functions are performed with the assistance of a local property manager.

### PRIORITY CLAIM

This application is a non-provisional of and claims priority to provisional application 60/702,884 filed Jul. 27, 2005 which is incorporated herein by reference.

### TECHNICAL FIELD

The present disclosure relates in general to property management, and, in particular, to methods and apparatus for managing a plurality of geographically dispersed rental properties.

### BACKGROUND

An owner of a rental property such as a house or apartment needs to manage or have someone else manage that property. Management functions include showing potential new tenants the rental property, screening potential new tenants, completing leasing paperwork, collecting rent, paying bills, paying taxes, overseeing repairs, etc.

Typically, one person or one company performs the property management function for a plurality of local rental properties or units. For example, a manager of an apartment building may live in the apartment building and manage dozens of the apartments in the building or building complex. Larger facilities may require a small staff of local managers. For example, a resort may have a large number of individually owned condominiums that are available for guests to rent. In such an instance, the resort may employ several people to manage the condominiums.

Importantly, these property managers are typically located near the rental properties they manage. This proximity enables the property managers to efficiently perform their functions. For example, a property manager may receive a call from a tenant that a pipe is leaking. In response, the property manager may need to go to the rental unit within a short period of time to inspect the leak. In addition, the property manager may need to hire a plumber, give the plumber access to the building, verify the leak has been fixed, and/or pay the plumber.

When rental properties are not physically located near each other, the efficiency of managing the rental properties decreases. For example, if ten rental properties are individually scattered across a large city, the manager of those properties may need to travel frequently from one property to another property to perform his/her property management functions. This problem is compounded when the properties are located across a state, multiple states, or a country. Even if the property manger has enough time to manage the dispersed properties, this travel time is unproductive overhead and may cause unacceptable delays and expenses.

To avoid such expenses and delays, a property manager could be hired for each individual property. However, having one property manger per property can be cost prohibitive. To reduce the cost of a dedicated property manger, an owner of such geographically disperse rental properties could attempt to hire a plurality of local property managers that also manage other owner's properties. However, for large property owners, this creates an organizational problem. For example, a landfill company often ends up owning a few rental properties near each landfill as a side effect of the land purchase associated with a new landfill or operation of a landfill. Such a company may own thousands of rental properties scattered across the entire United States. Attempting to hire and communicate with a different property manager for each location is burdensome, time consuming, inefficient and cost prohibitive.

### SUMMARY

The methods and apparatus disclosed herein enable a plurality of rental properties to be managed by a central property management system through a network of local property managers (e.g., real estate agents/brokers) who are not directly employed by a central property manager. The method and apparatus streamlines many aspects of property management, such as collections, lease management, and repair dispatching into a central call/operations center. In one embodiment, the central property management system provides the local property managers with up to date reminders of critical dates, rental income and expense data and other services that are important to the management process through a web based property management system that is managed by the central property manager, but accessible to the local property managers. In this manner, the cash management and over all management is controlled by the central property manager for the benefit of reducing the need of the local property managers to perform large amounts of detailed work per rental unit and reducing the knowledge and skill needed to perform the work. As a result, local property management functions (e.g., inspecting a repair) may be handled by less qualified part-time property managers/real estate agents/real estate brokers or fulltime professional property managers that receive their instructions from a central computer and/or central property manager. For example, the local property managers may be real estate agents that spend only a portion of their time performing local property manager functions for the central property management system. It should be appreciated that the functions described herein may in alternative embodiments be performed automatically, manually, or in combinations thereof.

Additional features and advantages are described herein, and will be apparent from, the following Detailed Description and the figures.

### BRIEF DESCRIPTION OF THE DRAWINGS

FIG. 1 is a high level block diagram of one embodiment of the present disclosure.

FIG. 2 is a block diagram showing one example of a computing device of one embodiment of the present disclosure.

FIG. 3 is a flowchart of an example rental cash flow process of one embodiment of the present disclosure.

FIG. 4 is a flowchart of an example maintenance workflow process of one embodiment of the present disclosure.

FIG. 5 is a flowchart of an example maintenance purchase order process of one embodiment of the present disclosure.

FIG. 6 is a flowchart of an example new vacancy process of one embodiment of the present disclosure.

FIG. 7 is a flowchart of an example new tenancy process of one embodiment of the present disclosure.

FIG. 8 is a flowchart of an example late payment collection process of one embodiment of the present disclosure.

FIG. 9 is an organization chart showing various example relationships between the central property manager and the local property managers of one embodiment of the present disclosure.

FIG. 10 is a flowchart of an example due diligence process of one embodiment of the present disclosure.

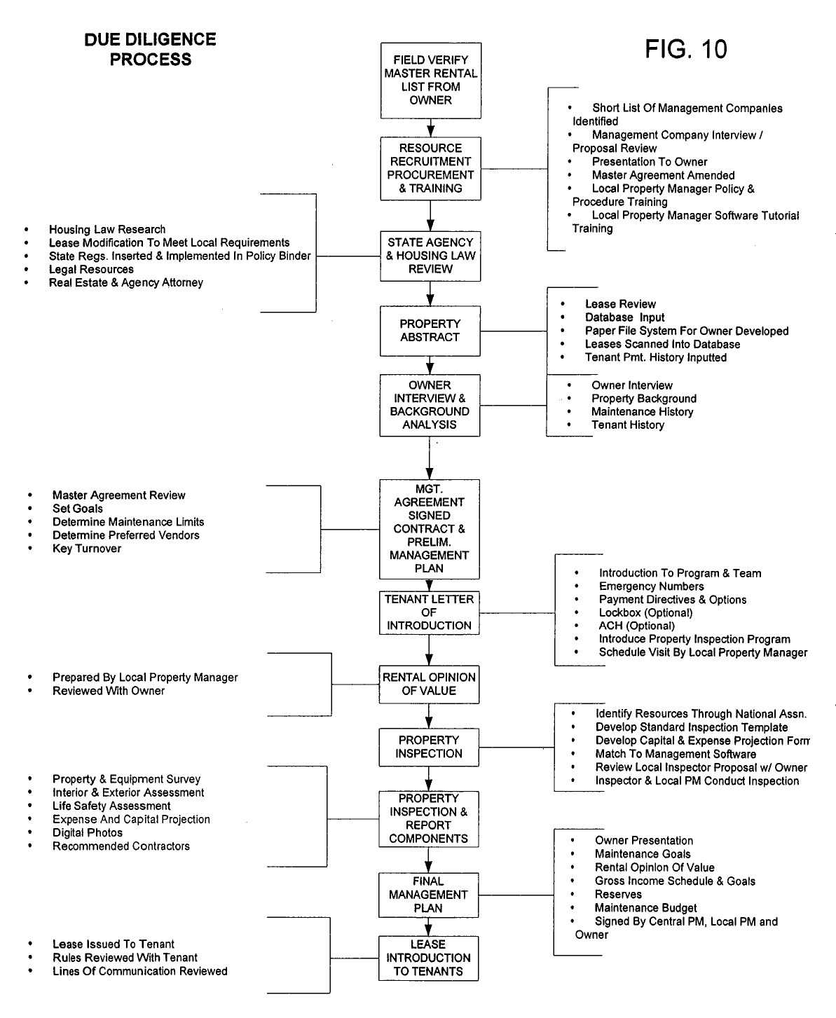

### DETAILED DESCRIPTION OF EXEMPLARY EMBODIMENTS

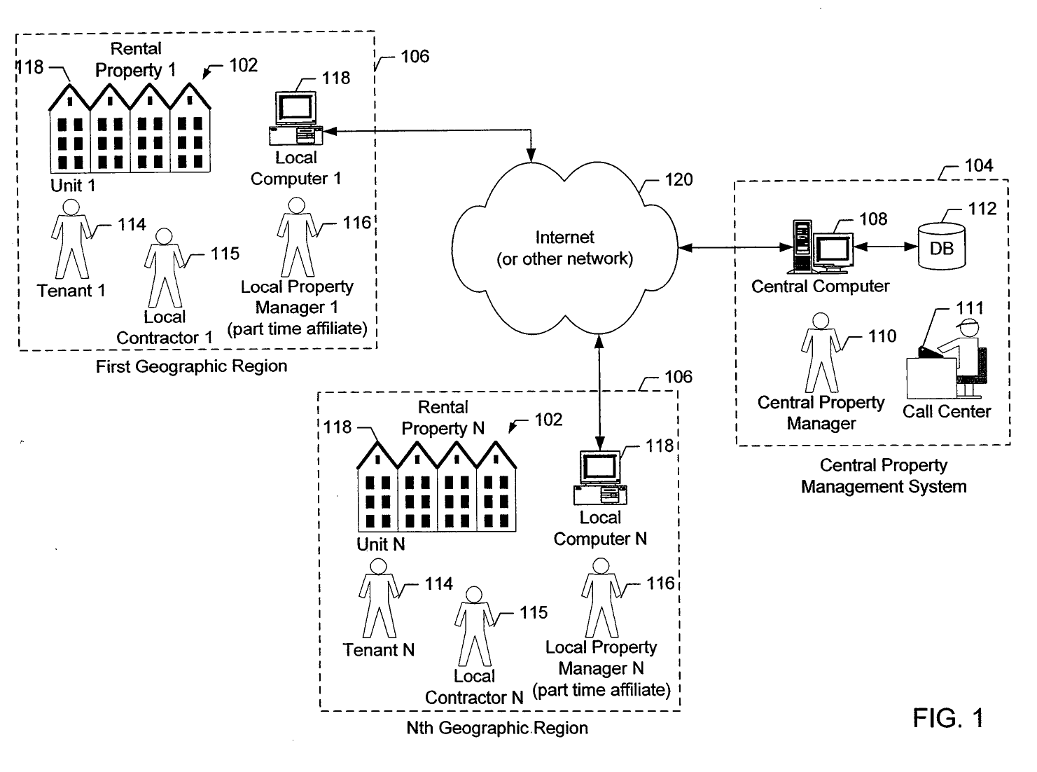

Referring now to FIG. 1, the methods and apparatus disclosed herein enable a plurality of rental properties 102 to be managed by a central property management system 104 through a network of local property managers (e.g., real estate agents/brokers) who are not directly employed by a central property manager 110. The central property management system and local property managers are particularly suited to co-act to manage individual rental properties 102 which may be too small to justify a dedicated property manager and may be located in a plurality of different geographic regions 106.

In various embodiments certain of the property management functions, such as rent collection, processing, and tracking are performed automatically by a central computer 108 that is part of the central property management system 104. Other property management functions, such as maintenance purchase order approvals, are performed by the central property management system 104 with the assistance of one or more central property managers 110. It should be appreciated that in various embodiments, the central manager will perform many manual items and notifications to the tenants and local managers. It should thus be appreciated that throughout this disclosure, if a step of the method is said to be performed manually, it may be automated, and if the step is said to be automated, it may be done manually. In one embodiment, the central property management system 104 includes a database 112 to facilitate these automatic and semi-automatic property management functions. The database 112 stores information about or associated with the rental properties 102, the tenants 114, repair vendors 115, etc.

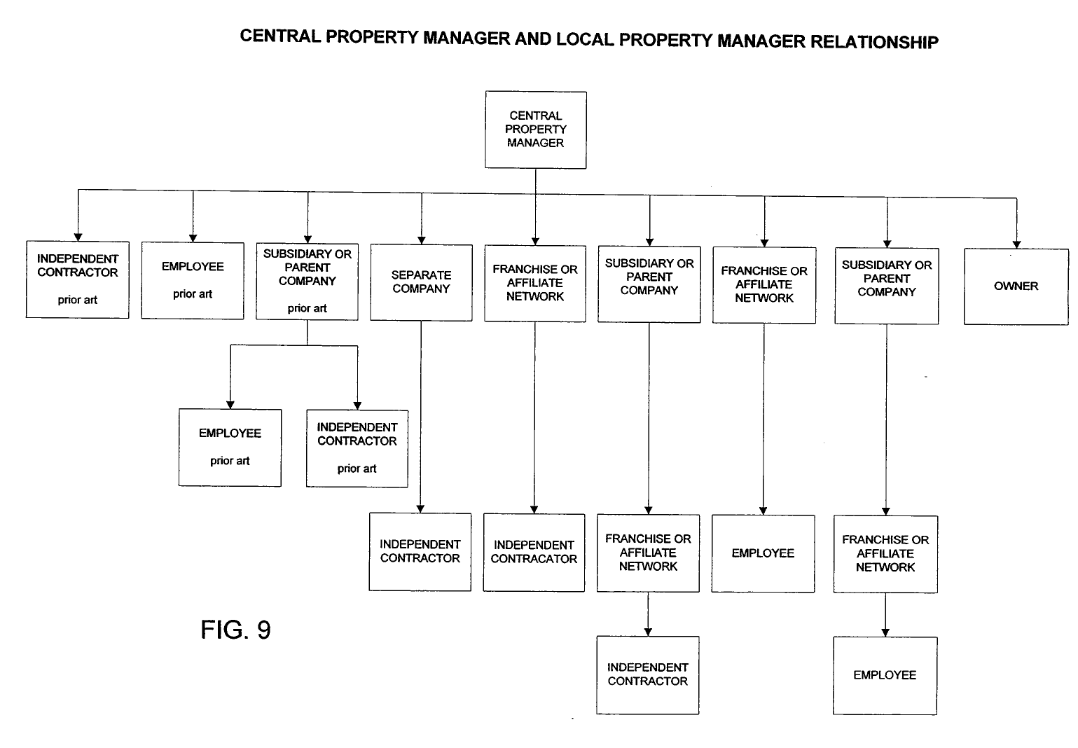

Other property management functions are best performed with the assistance of a local property manager 116. For example, if a particular unit 118 of a property 102 requires a repair, the local property manager 116 may be used to verify the need for the repair, send a digital picture or other evidence of any damage to the central computer 108, let a contract repair person into the unit 118, and verify completion of the repair including sending another digital picture or other evidence of the repairs to the central computer 108. The local property managers 116 may be full time or part time property managers who are part of an affiliate or franchise network. However, the legal relationship between the central property manager and a local property manager may take on any suitable form (see, for example, FIG. 9). For example, the local property managers 116 may be real estate agents that spend a portion of their time performing local property manager functions for the central property management system 104, thereby obtaining benefits from belonging to an affiliate network that creates the opportunity to provide clients with a single source property management provider and to provide the local property manager with a new source for reoccurring revenue, property management training and related property lease/sales commissions.

In various embodiments, the local property managers 116 receive their instructions manually or automatically via a local computer 118 connected to the central computer 108 through a wide area network 120 such as the Internet. For example, the central computer 108 may automatically send an e-mail to a local property manager 116 requesting the local property manager to let a repair person into a unit 118 at a certain time on a certain date. Alternatively, a central system operator may send such message to the local property manager. In this and other examples, the local property manager 116 may need to send a confirmation message to the central computer 108/central manager (e.g., to indicate that the scheduled time is acceptable to the local property manager 116). In addition, the central computer 108 may generate a web page and/or batch report for the local property manager 116 including a list of all the local property manager's outstanding action items. The local property manager 116 may view his/her web page or batch report from the local computer 118 and/or any computing device connected to the network 120.

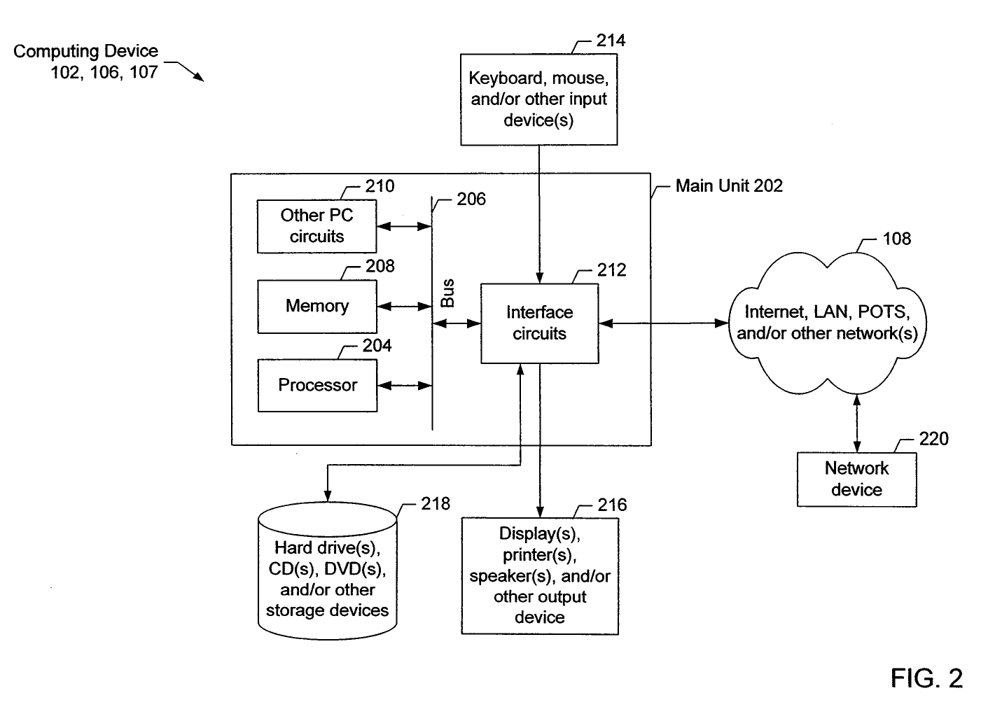

A more detailed block diagram of a computing device 108, 118 is illustrated in FIG. 2. The computing device 108, 118 may include a personal computer (PC), a personal digital assistant (PDA), an Internet appliance, a cellular telephone, or any other suitable communication device. The computing device 108, 118 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system as described below. This program may be executed by the processor 204 in any suitable manner. The memory 208 may also store digital data indicative of documents, files, programs, web pages, etc. retrieved from another computing device 108, 118 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the computing device 108, 118. For example, the display 216 may be used to display web pages and/or e-mail messages received from another computing device 108, 118. The visual displays may include prompts for human input, run time statistics, calculated values, data, etc. For example, a website and/or an e-mail message may be viewed on the display 216 reminding a local property manager 116 of an upcoming appointment with a local contractor 115.

One or more storage devices 218 may also be connected to the main unit 202 via the interface circuit 212. For example, a hard drive, CD drive, DVD drive, and/or other suitable storage devices may be connected to the main unit 202. The storage devices 218 may store any suitable type of data used by the customer computer 102.

The computing device 108, 118 may also exchange data with other network devices via a connection to the network 120. The network connection may be any type of suitable network connection, such as an Ethernet connection, digital subscriber line (DSL), telephone line, coaxial cable, etc. Users of the system may be required to register with the central computer 108. In such an instance, each user may choose a user identifier (e.g., e-mail address) and a password which may be required for the activation of services. The user identifier and password may be passed across the network 120 using encryption built into the user's browser. Alternatively, the user identifier and/or password may be assigned by the central computer 108.

Local computers 118 may connect to the central computer 108 to access data and view or generate reports. For example, the central computer 108 (and/or other computers) may host a website for the local computers 118. Access to the central computer 108 may be controlled by appropriate security software or security measures. An individual member's access can be defined in the system and limited to certain data, information and/or reports.

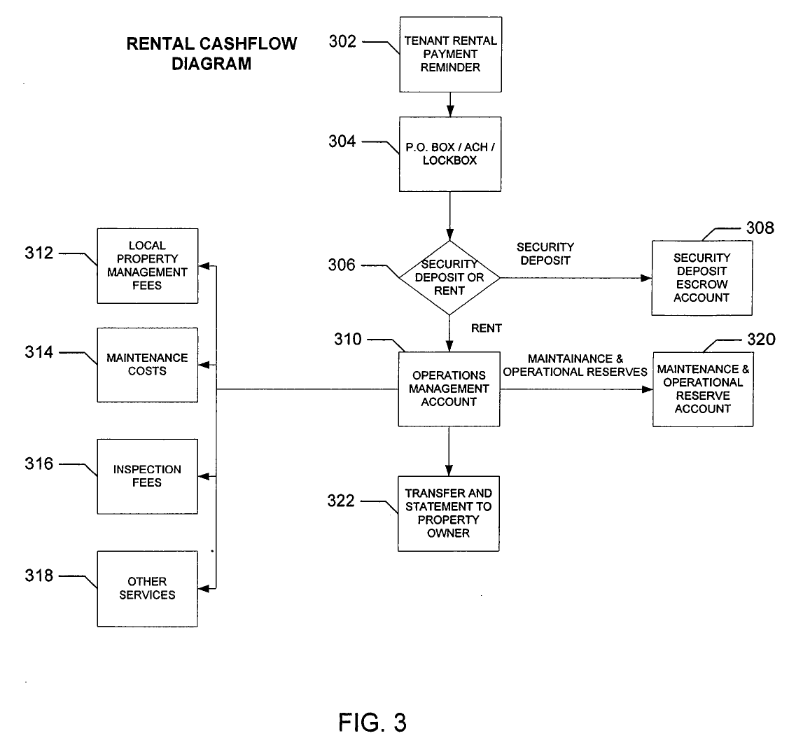

An example rental cash flow process is illustrated in FIG. 3. In general, the process uses the central property management system 104 and/or a local property manager 116 to collect rent from a tenant 114 and disburse collected rent to a plurality of central accounts. Preferably, the process is performed by one or more people and/or embodied in one or more software programs. Although the process is described with reference to the illustrated flowchart, it will be appreciated that many other alternative methods of performing the acts associated with process may be used. For example, the order of many of the steps may be changed, and some of the steps described may be optional. Additionally, the steps may be performed manually, automatically, or in a suitable automated and manual combination.

In this example, the tenant 114 is given a reminder to make a rental payment (block 302). Preferably the central property management system 104 sends an automatic message to remind the tenant 114 to pay the rent. For example, the central property management system 104 may send the tenant 114 an e-mail message reminding the tenant 114 of the amount due and the due date. Alternatively, or in addition, the central property management system 104 may send an electronic reminder to the local property manager 116 to collect the rent form the tenant 114. Electronic messages between the central property management system 104 and one or more local property managers 116 may be by e-mail, via a property management system website, and/or via any other suitable communications system. Alternatively, or in addition, the central property management system 104 may send the tenant 114 and/or the local property manager 116 reminders, rental bills, and/or any other information by regular mail.

The tenant 114 may pay the rent in any suitable manner (block 304). For example, the tenant 114 my mail a check for the rent to a post office box or drop the payment in a lock box. The rent check may be picked up from the post office box and/or the lock box by a local property manager 116 and then mailed to the central property management system 104, or the rent check may be sent directly to the central property management system 104. Alternatively, the tenant 114 may send an electronic payment for the rent. In one embodiment, the tenant 114 is given a suitable rent reduction if rent payments are made electronically. In alternative embodiments, rent is not paid to the management system. Rather, the management system tracks the rent that is deposited in various deposit accounts via lock box, direct deposit, etc.

The central property management system 104 determines if the check is for rent or for a security deposit (block 306). If the check is for a security deposit, the central property management system 104 deposit's the check in a security deposit escrow account (block 308). If the check is for a periodic rental payment, the central property management system 104 deposit's the check in an operations management account (block 310).

From the operations management account, the cash flows to certain expenses, cash reserves, and profits. For example, a portion of the rental payment may be used for monthly expenses such as local property management fees (block 312), maintenance costs (block 314), inspection fees (316), and/or other expenses (block 318). Another portion of the rental payment may be placed into a maintenance and operational reserve account (block 320). The remaining portion is preferably transferred to the property owner along with a monthly statement (block 322). This can alternatively be done on a quarterly or other basis.

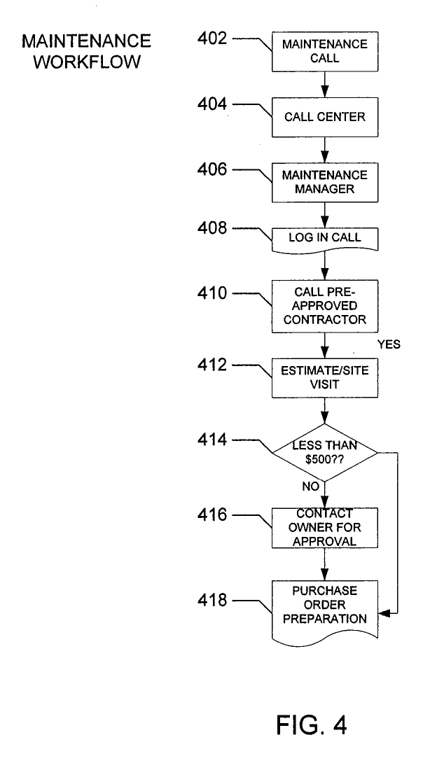

An example maintenance workflow process is illustrated in FIG. 4. In general, the process uses the central property management system 104 and/or a local property manager 116 to respond to a tenant's request for maintenance by requesting a quote from one or more local contractors 115. In various embodiments, the process is performed by one or more people and/or embodied in one or more software programs. Although the process is described with reference to the illustrated flowchart, it will be appreciated that many other methods of performing the acts associated with process may be used. For example, the order of many of the steps may be changed, and some of the steps described may be optional.

In this example, the tenant 114 makes a call to request certain maintenance (block 402). For example, the tenant 114 may be calling to report the garbage disposal does not work. The maintenance call is preferably made to a call center 111 that is part of the central property management system 104 (block 404). The maintenance call is handled by a central maintenance manager who is connected to or located at the call center 111 (block 406). The central maintenance manager may be a call center employee, the central property manager 110, and/or a maintenance specialist of the central property management system 104. By handling maintenance calls centrally, the local property managers 116 are not bothered by routine maintenance calls.

Each maintenance call is logged by the call center 111 (block 408). For example, the call center 111 preferably records the time of each call, the duration of each call, the origination phone number of each call, the nature of the maintenance request, etc. In one embodiment, the maintenance manager queries the database 112 to determine if this repair request seems reasonable. The database 112 may hold purchase and maintenance records for each major appliance (e.g., washer, dryer, etc.) and each upkeep item (e.g., painting, roof, etc.) for each rental unit 118. For example, the database 112 may store the purchase date and any maintenance associated with the garbage disposal installed in a particular rental unit 118. In addition, the database 112 may store digital photographs from before and after repairs sent from a local property manager. If a repair request seems unusual (e.g., based on expected life span), a message may be sent to the central property manager 110 and/or the property owner.

The maintenance manager then contacts one or more pre-approved maintenance contractors 115 for that geographical area (block 410). For example, the maintenance manager may retrieve a list of preapproved vendors in that area for that type of repair from the database 112. The contractor(s) 115 then gives the maintenance manager an estimate (block 412). In some instances, the contractor 115 may be able to provide the estimate without visiting the property (e.g., install new air condition unit). In other instances, the contractor 115 may need to visit the property site in order to provide the estimate (e.g., painting).

If the contractor 115 requires access to the property (for the estimate and/or to perform the maintenance operation), the maintenance manager may make arrangements with the tenant 114 to give the contractor 115 access to the property. However, this approach is not always practical. Accordingly, the maintenance manager may make arrangements with the local property manager 116 to give the contractor 115 access to the property.

If the estimate from the contractor 115 is below a predetermined threshold (block 414), then the maintenance manager may approve the maintenance procedure and prepare a purchase order (block 418). The predetermined threshold may be a certain dollar amount (e.g., $500), a certain dollar amount based on the maintenance procedure (e.g., $500 for plumbing, $1000 for painting, etc.), a percentage of rent, and/or a percentage of revenue. In addition, the dollar amounts of repairs may be accumulated over a certain time period and compared to a predetermined threshold.

If the estimate from the contractor 115 is not below the predetermined threshold (block 414), then the maintenance manager may contact the property owner for approval (block 416). For example, if a building needs a new roof, the property owner may need to be contacted to discuss different options.

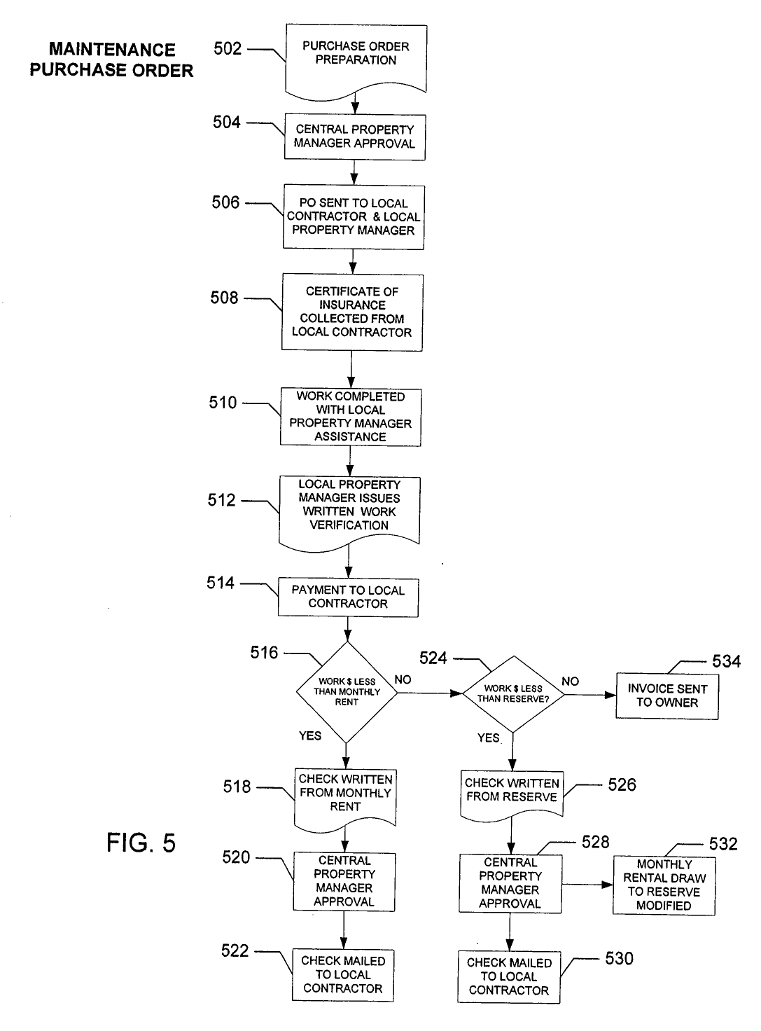

An example maintenance purchase order process is illustrated in FIG. 5. In general, the process uses the central property management system 104 and/or a local property manager 116 to verify the completion of a maintenance procedure and pay the maintenance contractor. Preferably, the process is performed by one or more people and/or embodied in one or more software programs. Although the process is described with reference to the illustrated flowchart, it will be appreciated that many other methods of performing the acts associated with process may be used. For example, the order of many of the steps may be changed, and some of the steps described may be optional.

In this example, a purchase order is prepared (block 502) and approved by the central property manager 110 (block 504). The purchase order is then sent to the local contractor 115 and the local property manager 116 (block 506). For example, if a particular property requires a new garbage disposal, a purchase order for the new garbage disposal and the installation is written and sent to a pre-approved local contractor 115 and to the local property manager 116. The purchase order may be sent automatically by e-mail, fax, regular mail, and/or any other suitable means. Preferably, each local property manager 116 and each local contractor 115 is associated with a message delivery method in the central database 112. For example, the local contractor 115 selected may be associated with a fax number, and the local property manager 116 may be associated with an e-mail address.

Once a certificate of insurance is collected from the local contractor 115 (block 508), and the work is completed with the local property manager's assistance (block 510), the local property manager 116 issues a written work verification (block 512). For example, the local property manager 116 may unlock the door for the local contractor 115, remain on site during the installation of the new garbage disposal, verify the new disposal works properly and that the property was left in an orderly manner, and complete an online form from the central computer 108 (or other web server) indicating the work was completed.

Once the work is completed and approved by the local property manager 116, the local contractor 115 is paid by the central property management system 104 (block 514). If the money owed to the local contractor 115 is less than the monthly rent for the property (block 516), the check to the local contractor 115 is written from the monthly rent check for the property (block 518). Upon approval from the central property manager 110 (block 520), the check is mailed to the local contractor 115 (block 522). It will be appreciated that electronic payments or other forms of payment may be used instead of checks for any of the payments made by the present disclosure.

If the money owed to the local contractor 115 is more than the monthly rent for the property (block 516) and less than the amount of money in reserve for this property (block 524), the check to the local contractor 115 is written from the reserve funds for the property (block 526). Upon approval from the central property manager 110 (block 528), the check is mailed to the local contractor 115 (block 530). In addition, if the reserve funds are used, the monthly rental draw to reserve is modified to replenish the reserve funds used (block 532).

If the money owed to the local contractor 115 is more than the monthly rent for the property (block 516) and more than the amount of money in reserve for this property (block 524), an invoice is sent to the owner and/or landlord of the property (block 534).

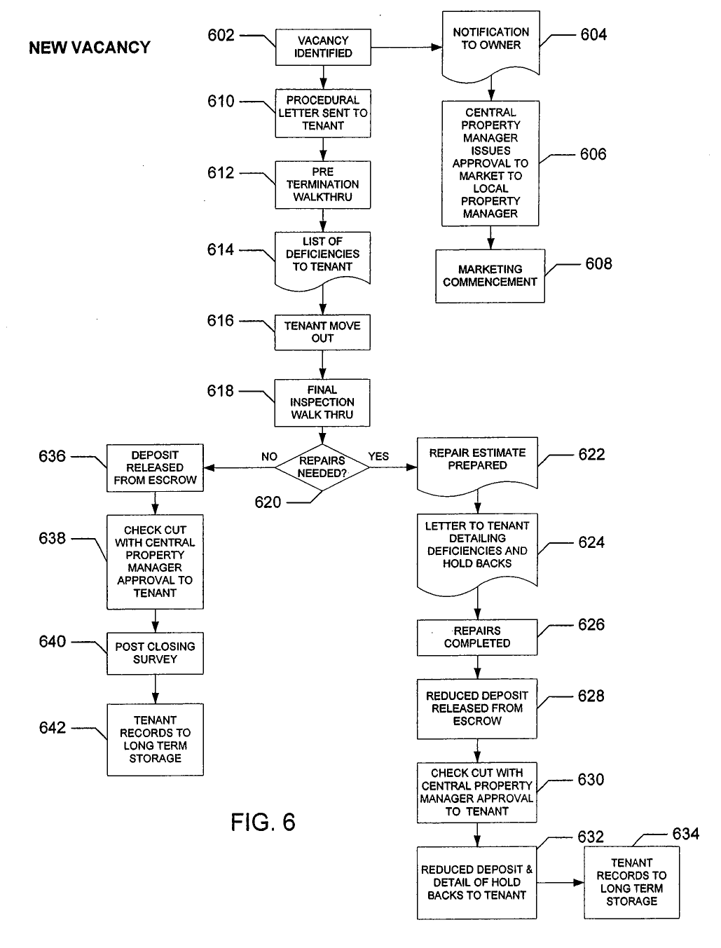

An example new vacancy process is illustrated in FIG. 6. In general, the process uses the central property management system 104 and/or a local property manager 116 to move a tenant 114 out of a unit 118 and identify any needed repairs. Preferably, the process is performed by one or more people and/or embodied in one or more software programs. Although the process is described with reference to the illustrated flowchart, it will be appreciated that many other methods of performing the acts associated with process may be used. For example, the order of many of the steps may be changed, and some of the steps described may be optional.

In this example, once a new vacancy is identified (block 602), the owner and/or landlord of the property is notified (block 604), and the central property manager 110 issues a market approval to the appropriate local property manager 116 (block 604). In response, the local property manager 116 begins marketing the new vacancy (block 606). For example, in response to a lease renewal request automatically sent from the central property manager 110 to the tenant 114, the tenant 114 may send a notice to the central property manager that he does not intend to renew his lease. The central property manager 110 then sends a message (e.g., e-mail or web page) to the local property manager 116 associated with the property to try to fill the upcoming vacancy.

In addition, once a new vacancy is identified (block 602), the central property manager 110 sends a procedural letter to the tenant 114 (block 610). As part of the lease termination process, the central property manager 110 sends a message to the local property manager 116 to perform a pre-termination walkthrough of the property (block 612). After the pre-termination walkthrough, the local property manager 116 generates a list of deficiencies for the tenant 114 (block 614). For example, the central property manager 110 may send the local property manager 116 a walkthrough checklist. In one embodiment, the information form the checklist is also entered into the central computer 108 (e.g., via a website). After the tenant 114 moves out (block 618), the central property manager 110 sends a message to the local property manager 116 to perform a final inspection walkthrough (block 618).

If the local property manager 116 determines that repairs are needed (block 620), a repair estimate is prepared (block 622). For example, the local property manager 116 may fill out a final inspection report from the central computer 108 (e.g., via a website). In response, the central property manager 110 contacts one or more pre-approved local contractor 115 to prepare the repair estimate. Once the estimate is complete, the central property manager 110 sends the former tenant 114 a letter detailing the deficiencies and the holdbacks from the tenant's deposit (block 624).

Once the repairs are completed (block 626), the remaining deposit is released from escrow (block 628). Upon central property management approval, a check or electronic payment for the remaining deposit (i.e., less the repair cost) is produced (block 630) and sent to the former tenant 114 along with a detailed statement of the repairs needed and the holdbacks associated with those repairs (block 632). The former tenant 114 records are placed in long term storage (block 634). For example, the central property manager 110 may send a message to the local property manager to unlock the property for the local contractor 115 so the repairs may be performed. Upon completion of the repairs, the local property manager 116 preferably inspects the repairs and sends a message to the central property manager 110 that the repairs are complete. In addition, the local contractor 115 and/or the local property manager send a message to the central property manager indicating what repairs were performed and the cost of the repairs. This information is then used to reduce the former tenant 114's deposit and generate the detailed statement of the repairs for the former tenant 114. The record of all repairs can be entered into the central system database to track status of each rental property.

If the local property manager 116 determines that repairs are not needed (block 620), the entire deposit is release from escrow (block 636). Upon central property management approval, a check or electronic payment for the entire deposit is sent to the former tenant 114 (block 638) and a post closing survey is generated (block 640). The former tenant 114 records are placed in long term storage (block 642).

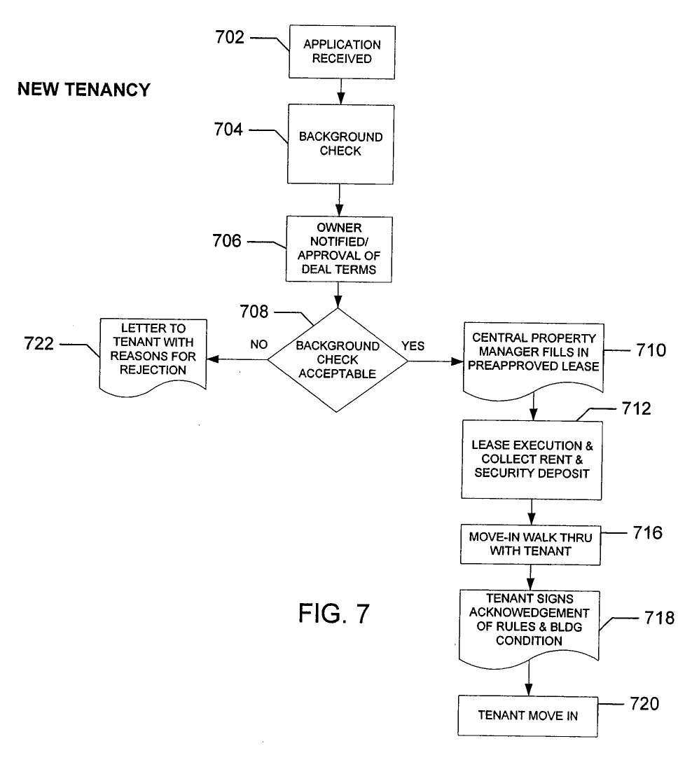

An example new tenancy process is illustrated in FIG. 7. In general, the process uses the central property management system 104 and/or a local property manager 116 to qualify and move anew tenant 114 into a unit 118. Preferably, the process is performed by one or more people and/or embodied in one or more software programs. Although the process is described with reference to the illustrated flowchart, it will be appreciated that many other methods of performing the acts associated with process may be used. For example, the order of many of the steps may be changed, and some of the steps described may be optional.

In this example, once an applications is received (block 702), a background check is performed (block 704). The application may be received by the central property manager 110 and/or the local property manager 116. For example, the local property manager 116 may show the property to a potential tenant 114 and then give the potential tenant 114 a paper application. Alternatively, the potential tenant 114 may fill out an application from the central computer 108 (e.g., from a website). In either event, the local property manager 116 may assist the potential tenant 114 with the application process. Preferably, the central property manager 110 performs or commissions the background check.

Once the background check is complete, and the owner and/or landlord of the property approves the terms of the deal (block 706), the central property manager 110 determines if the results of the background check are acceptable (block 708). If the results of the background check are acceptable, the central property management system 104 generates a pre-approved lease (block 710). The lease is then executed by the new tenant 114, and the first rent payment and security deposit are collected (block 712). The lease may be sent from the central property manager 110 to the potential tenant 114 and returned to the central property manager, or the local property manager 116 may handle lease execution. In either event, the original lease is preferably held by the central property manager 110. Similarly, the first rent payment and/or security deposit may be sent directly to the central property manager 110 or collected by the local property manager and forwarded to the central property manager 110.

Once the lease is executed, the local property manager 116 performs a move-in walkthrough with the new tenant 114 (block 716). In addition, the new tenant 114 signs an acknowledgement of the rules and an acknowledgment of the current building condition (block 718). Preferably, the acknowledgement of the current building condition is handled by the local property manager 116 and forwarded to the central property manager 110. A copy of the rules may be sent to the tenant 114 from the central property manager 110 and/or given to the tenant 114 by the local property manager 116. The acknowledgement of the rules (e.g., a signed copy of the rules) may be sent from the tenant 114 directly to the central property manager 110 and/or given to the local property manager 116 by the tenant 114 and forwarded to the central property manager 110. Subsequently, the tenant 114 may move in to the property (block 720).

If the results of the background check are not acceptable, the central property manager 110 sends a letter to the potential tenant 114, and in some embodiments, with the reasons for the rejection (block 722).

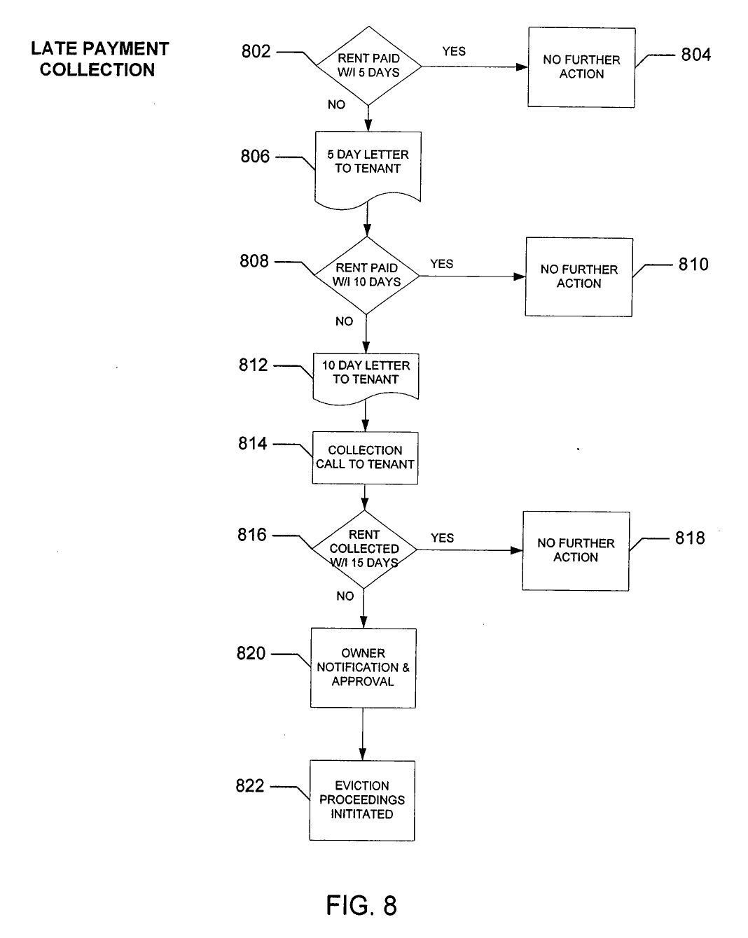

An example late payment collection process is illustrated in FIG. 8. In general, the process uses the central property management system 104 and/or a local property manager 116 to collect rent from a tenant 114. In various embodiments, the process is performed by one or more people and/or embodied in one or more software programs. Although the process is described with reference to the illustrated flowchart, it will be appreciated that many other methods of performing the acts associated with process may be used. For example, the order of many of the steps may be changed, and some of the steps described may be optional.

In this example, if a particular rent is not past due (block 802), then no further action needs to be taken by the central property manager 110 or the local property manager 116 (block 804). For example, the system may be programmed to do nothing until a rent becomes more than five days past due. If the rent is a first threshold period of time past due (block 802), the central property management system 104 automatically sends the tenant 114 a late payment letter (block 806).

If the rent is paid within a second threshold period of time (block 808), then no further action needs to be taken by the central property manager 110 or the local property manager 116 (block 810). For example, the system may be programmed to take no further action if the rent is paid within ten days of the due date. If the rent is more than the second threshold period of time past due (block 808), the central property management system 104 automatically sends the tenant 114 a second late payment letter (block 812). In addition, a collection call may be made to the tenant 114 (block 814). In one embodiment, the central property manager 110 makes a live collection call and/or an automated collection call. Alternatively, or in addition, the central property manager may send an automatic message (e.g., an e-mail message) to the local property manager 116 instructing the local property manager 116 to make the collection call. In response, the local property manager 116 may make a telephone call to the tenant 114 and/or visit the property.

If the rent is paid within a third threshold period of time (block 816), then no further action needs to be taken by the central property manager 110 or the local property manager 116 (block 818). For example, the system may be programmed to take no further action if the rent is paid within fifteen days of the due date. If the rent is more than the third threshold period of time past due (block 816), the property manger is notified (block 820). Upon approval by the owner and/or landlord of the property (block 820), eviction proceedings are initiated by the central property manager (block 822).

It should be appreciated that the present method and apparatus is thus capable of providing a standardize wide (such as national) process and procedure with standardized consolidated reports and financial information for owners of multiple properties in a plurality of geographically remote markets. Such information on their properties can be consolidated into an easy to read and understandable asset management report.

It should further be appreciated that the present disclosure provides the opportunity for owners of geographically disbursed properties to have a single process, procedure and financial reporting structure across their portfolio. These reports can be consolidated in a single rollup report for true topside management.

It should also be appreciated that the present disclosure provides additional sale opportunities for agents and brokers from the tenants of the rental properties and by the national referral network that will develop using the present disclosure. The system will thus increase the revenue for agents, brokers and their companies.

It should also be appreciated that the present disclosure provides the ability for a franchise/affiliate network with consistent: branding, consolidated advertising, training, process/procedure, referrals, legal resources, forms, and expert advice, etc. Thus, the present disclosures provides a method and apparatus for more efficient, more economical remote rental property management.

In summary, persons of ordinary skill in the art will readily appreciate that methods and apparatus for managing a plurality of geographically dispersed residential properties have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention not be limited by this detailed description of examples.

What is claimed is:

1. A method of managing a plurality of geographically dispersed residential properties, the method comprising:
executing a first contract between a central property management company and a first affiliate to provide first local property management services for a first property, the first affiliate being a first individual that is licensed to manage real estate that is not an employee of the central property management company, the first affiliate and the first property being located in a first area, the first property being owned by a first property owner;
executing a second contract between the central property management company and a second affiliate to provide second local property management services for a second property on a full or part time basis, the second affiliate being a second individual that is licensed to manage real estate that is not an employee of the central property management company, the second affiliate and the second property being located in a second area that is different than the first area, the second property being owned by a second property owner or owner of multiple properties located in a plurality of markets, wherein each of the central property management company, the first affiliate, the second affiliate, the first property owner, and the second property owner are different entities;
sending a first automatic electronic message from the central property management company to a tenant of the first property to accomplish a first property management activity that does not require a physical visit to the first property; and
sending a second automatic electronic message from the central property management company to the first affiliate to perform a second property management activity that does require a physical visit to the first property.

2. The method of claim 1, including:
receiving a repair request, the repair request going from a tenant to the central property management company;
selecting a repair company;
sending instructions associated with a repair job from the central property management company to the first affiliate;
sending repair completion information from the first affiliate to the central property management company; and
paying the repair company for the repair job.

3. The method of claim 2, including:
maintaining a database associating appliance purchase dates, appliance maintenance dates, and rental unit identifiers;
querying the database in response to a repair request; and
sending an electronic message if a repair request comes earlier than a threshold date determined using the database.

4. The method of claim 2, including sending a digital picture from the first affiliate to the central property management company.

5. The method of claim 4, wherein the digital picture is stored in a database in association with the rental unit identifier.

6. The method of claim 2, wherein the repair company is selected from a database of preferred vendors associated with the central property management company.

7. The method of claim 2, wherein the instructions associated with the repair job include when to allow access by the selected repair company to a particular rental unit associated with the tenant.

8. The method of claim 2, wherein sending repair completion information includes sending a digital picture.

9. The method of claim 8, wherein the digital picture is stored in a database in association with the rental unit identifier.

10. A method of managing a plurality of geographically dispersed residential properties, the method comprising:
performing a first property management function automatically by a computer system associated with a central property management company;
performing a second property management function manually by a first person associated with the central property management company;
performing a third property management function manually by a second different person in response to an automatic electronic message from the computer system associated with the central property management company, the second person not being an employee of the central property management company, the second person being located remote from the central property management company; and
performing a fourth property management function manually by the second person in response to a manual message from a third person associated with the central property management company.

11. The method of claim 10, including:
receiving a repair request, the repair request going from a tenant to the second person;
sending repair assessment information from the second person to the computer system associated with the central property management company;
selecting a repair company;
sending instructions associated with a repair job from the computer system to the second person;
performing a fifth property management function manually by the second person in response to the instructions associated with the repair job;
sending repair completion information from the second person to the computer system associated with the central property management company; and
paying the repair company for the repair job.

12. The method of claim 11, wherein sending repair assessment information from the second person to the computer system or central manager associated with the central property management company includes sending a digital picture from the second person to the computer system or central manager associated with the central property management company.

13. The method of claim 11, wherein the repair company is selected by the first person from a database of preferred vendors associated with the central property management company.

14. The method of claim 11, wherein the repair company is selected by the second person.

15. The method of claim 11, wherein the instructions associated with the repair job include when to allow access by the selected repair company to a particular rental unit associated with the tenant.

16. The method of claim 11, wherein performing the fifth property management function manually by the second person in response to the instructions associated with the repair job includes allowing access by the selected repair company to a particular rental unit associated with the tenant.

17. The method of claim 11, wherein sending repair completion information from the second person to the computer system associated with the central property management company includes sending a digital picture from the second person to the computer system associated with the central property management company.

18. The method of claim 11, wherein paying the repair company for the repair job includes having the central property management company pay the repair company for the repair job.

19. The method of claim 11, wherein paying the repair company for the repair job includes having the second person pay the repair company for the repair job and subsequently being paid by the first person.

20. The method of claim 10, wherein performing the first property management function automatically by the computer system associated with the central property management company includes reminding a tenant of a rent amount and a rent due date.

21. The method of claim 10, wherein performing the first property management function automatically by the computer system associated with the central property management company includes collecting a rent amount.

22. The method of claim 10, wherein performing the second property management function manually by the first person associated with the central property management company includes reminding a tenant of a rent amount and a rent due date.

23. The method of claim 10, wherein performing the second property management function manually by the first person associated with the central property management company includes collecting a rent amount.

24. The method of claim 10, wherein performing the third property management function manually by the second person in response to the automatic electronic message from the computer system associated with the central property management company includes reminding a tenant of a rent amount and a rent due date.

25. The method of claim 10, wherein performing the third property management function manually by the second person in response to the automatic electronic message from the computer system associated with the central property management company includes collecting a rent amount.

26. The method of claim 10, wherein performing the fourth property management function manually by the second person in response to the manual message from the third person associated with the central property management company includes reminding a tenant of a rent amount and a rent due date.

27. The method of claim 10, wherein performing the fourth property management function manually by the second person in response to the manual message from the third person associated with the central property management company includes collecting a rent amount.

28. The method of claim 10, wherein each property management function in the group of property management functions consisting of the first property management function, the second property management function, the third property management function, and the fourth property management function is different than each of the other property management functions in the group of property management functions.

29. The method of claim 10, wherein the first person associated with the central property management company is different than the third person associated with the central property management company.

30. The method of claim 10, wherein the first person associated with the central property management company is the same as the third person associated with the central property management company.

31. The method of claim 10, wherein the computer system associated with the central property management company includes a plurality of computing devices.
